(19) United States
(12) Patent Application Publication
(10) Pub. No.: US 2025/0055089 A1
(43) Pub. Date: Feb. 13, 2025

(54) SECONDARY BATTERY AND MANUFACTURING METHOD THEREOF

(71) Applicant: SAMSUNG SDI CO., LTD., Yongin-si (KR)

(72) Inventors: Byeonggwan LEE, Yongin-si (KR); Duseon PARK, Yongin-si (KR); Duckhyun KIM, Yongin-si (KR); Woonsuk JANG, Yongin-si (KR)

(21) Appl. No.: 18/621,557

(22) Filed: Mar. 29, 2024

(30) Foreign Application Priority Data
Aug. 10, 2023 (KR) 10-2023-0105066

(51) Int. Cl. H01M 50/167; H01M 50/103; H01M 50/15; H01M 50/533

(52) U.S. Cl. CPC H01M 50/167; H01M 50/103; H01M 50/15; H01M 50/533

(57) ABSTRACT

A secondary battery includes a can having a hexagonal bottom portion and a side portion having six surfaces, an electrode assembly accommodated inside the can, and a hexagonal cap plate coupled to an end of the side portion to seal the can, the side portion including a beading portion independently positioned on each of the six surfaces and crimping portions divided by cutouts.

### CROSS-REFERENCE TO RELATED APPLICATION

This application claims priority to and the benefit of Korean Patent Application No. 10-2023-0105066 filed in the Korean Intellectual Property Office on Aug. 10, 2023, the entire contents of which are incorporated herein by reference.

### BACKGROUND

### 1. Field

The present disclosure relates to a secondary battery, and more particularly, to a hexagonal pillar-shaped secondary battery.

### 2. Description of the Related Art

Secondary batteries are not only used as a power source for small electronic devices such as mobile phones and laptop computers, but have also recently been used as a power source for driving motors in transportation vehicles such as electric vehicles and hybrid vehicles. In the latter case, a battery module in which a plurality of secondary batteries are combined is used, and a typical battery module includes a plurality of cylindrical secondary batteries.

### SUMMARY

Embodiments include a secondary battery. The secondary battery includes a can having a hexagonal bottom portion and a side portion having six surfaces, an electrode assembly accommodated inside the can and a hexagonal cap plate coupled to an end of the side portion to seal the can, wherein the side portion includes a plurality of beading portions, a beading portion of the plurality of beading portions situated on each of the six surfaces and a plurality of crimping portions divided by a plurality of cutouts.

The electrode assembly may include a plurality of electrodes with different widths stacked along a width direction of the secondary battery and may be in the shape of a hexagon on a plane.

Each of the plurality of electrodes may have a square sheet shape, and the long side of each of the plurality of electrodes may be parallel to a length direction of the secondary battery, and a short side of each of the plurality of electrodes may be positioned parallel to any two facing surfaces among the six surfaces included in the side portion.

The electrode assembly may include a plurality of first tabs positioned on one side toward the hexagonal bottom portion and a plurality of second tabs positioned on another side toward the cap plate, and the secondary battery may further include a first current collecting plate connected to the plurality of first tabs and a second current collecting plate connected to the plurality of second tabs.

An opening may be positioned on the hexagonal bottom portion, and the secondary battery may further include a rivet inserted into the opening via a first insulator and electrically connected to the first current collecting plate.

The second current collecting plate may include a hexagonal current collector and a plurality of extension portions connected to at least two of the six sides of the current collector and in contact with an inner surface of a beading portion of the plurality of beading portions.

Each of the plurality of beading portions may have an arc shape on a plane and each of the plurality of extension portions may have a curvature corresponding to an inner curvature of the beading portion on a plane.

The plurality of cutouts may include a plurality of cut lines positioned parallel to a length direction of the secondary battery at an end of each of the six corners of the side portion, and each of the plurality of crimping portions may have an overlapping portion with an adjacent crimping portion.

The plurality of cutouts may include a plurality of V-shaped cut grooves positioned parallel to a length direction of the secondary battery at an end of each of the six corners of the side portion, and each of the plurality of crimping portions may be in contact with an adjacent crimping portion on a side surface.

Embodiments include a manufacturing method of a secondary battery. The method includes accommodating an electrode assembly in a can, the can including a hexagonal bottom portion and a side portion having six surfaces may be prepared, processing a plurality of beading portions, the processing including individually press molding each of the six surfaces of the side portion to create a plurality of beading portions, processing cutouts by applying an insulator over the plurality of beading portions and creating a plurality of cutouts parallel to a length direction of the secondary battery at each end of six corners of the side portion and processing crimping portions by disposing a cap plate at a center of the insulator and an end of the side portion may be bending molded toward the center of the cap plate to create a plurality of crimping portions.

In the processing of the plurality of beading portions, a jig may be positioned inside the side portion, a first pressing portion having an arc shape on one side facing the side portion and a rotating portion supporting the can, and press molding using the first pressing portion and rotating the rotating portion of the can by 60°, wherein the press molding is repeatedly performed.

In the processing of the cutouts, the plurality of cutouts include a plurality of cut lines, wherein in the processing of the crimping portions, a second pressing portion and a rotating portion supporting the can are used, and bending molding using the second pressing portion and rotation of the can by 60° by the rotating portion are repeatedly performed.

In the processing of the crimping portions, each of the plurality of crimping portions may have an overlapping portion with an adjacent crimping portion.

In the processing of the cutouts, the plurality of cutouts include a plurality of cut grooves, wherein in the processing of the crimping portions, six second pressing portions corresponding to each of the six surfaces of the side portion are used and the six second pressing portions simultaneously bending-mold the ends of the side portion.

In the processing of the crimping portions, each of the plurality of crimping portions may be in contact with an adjacent crimping portion on a side surface.

### BRIEF DESCRIPTION OF THE DRAWINGS

Features will become apparent to those of skill in the art by describing in detail exemplary embodiments with reference to the attached drawings in which:

FIG. 1 is a perspective view of a secondary battery according to one or more embodiments;

FIG. 2 is a cross-sectional view of the secondary battery taken along line A-A in FIG. 1 according to one or more embodiments;

FIG. 3 is a cross-sectional view of the secondary battery taken along line B-B in FIG. 1 according to one or more embodiment;

FIG. 4 is an exploded perspective view of the electrode assembly and current collecting plates of the secondary battery of FIG. 2 according to one or more embodiments;

FIG. 5 is a partial enlarged view of the electrode assembly of the secondary battery of FIG. 3 according to one or more embodiments;

FIG. 6 is a partial enlarged view of FIG. 2 according to one or more embodiments;

FIG. 7 is a cross-sectional view of the secondary battery cut along line C-C in FIG. 1 according to one or more embodiments.

FIG. 8 is a top plan view of the secondary battery of FIG. 1 according to one or more embodiments;

FIG. 9 is a perspective view showing a state before bending molding of the crimping portion of the secondary battery of FIG. 1 according to one or more embodiments;

FIG. 10 is a top plan view of a secondary battery according to one or more embodiments;

FIG. 11 is a perspective view showing a state before bending molding of the crimping portion of the secondary battery of FIG. 10 according to one or more embodiments;

FIG. 12 is a process flowchart showing a manufacturing method of a secondary battery according to one or more embodiments;

FIG. 13 is a schematic perspective view of a can, a first pressing portion and a rotating portion for explaining processing of beading portions shown in FIG. 12 according to one or more embodiments;

FIG. 14 is a schematic perspective view of a can, a second pressing portion and a rotating portion for explaining processing of the crimping portions shown in FIG. 12 according to one or more embodiments;

FIG. 15 is a top plan view of the can and the second pressing portion for explaining processing of the crimping portions shown in FIG. 12 according to one or more embodiments; and

FIG. 16 is a schematic diagram of a battery module according to one or more embodiments.

### DETAILED DESCRIPTION

Example embodiments will now be described more fully hereinafter with reference to the accompanying drawings; however, they may be embodied in different forms and should not be construed as limited to the embodiments herein. Rather, these embodiments are provided so that this disclosure will be thorough and complete, and will fully convey the scope of the disclosure to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

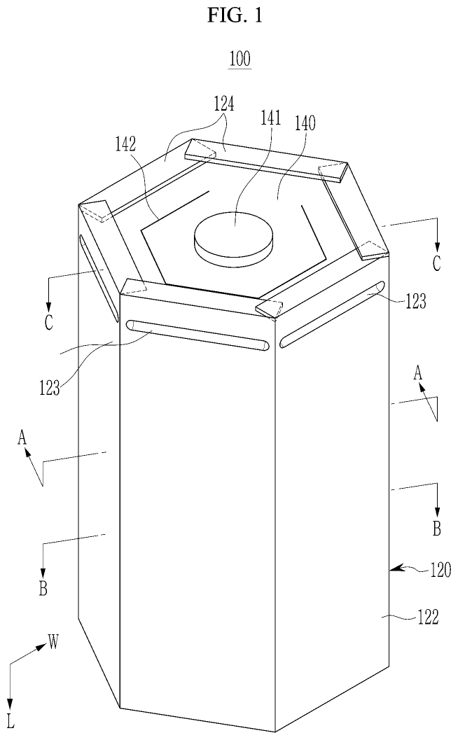

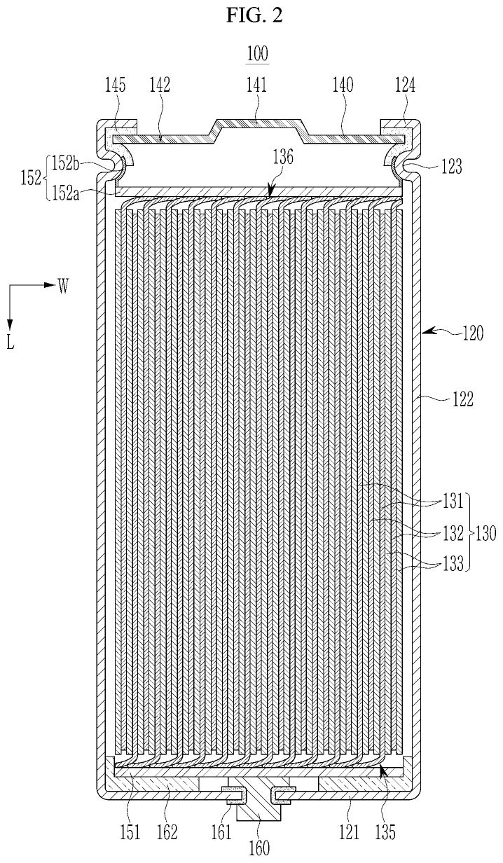

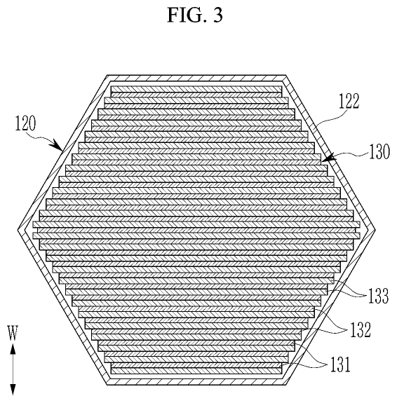

FIG. 1 is a perspective view of a secondary battery according to one or more embodiments. FIG. 2 is a cross-sectional view of the secondary battery taken along line A-A in FIG. 1 according to one or more embodiments, and FIG. 3 is a cross-sectional view of the secondary battery taken along line B-B in FIG. 1 according to one or more embodiments.

Referring to FIGS. 1 to 3, a secondary battery 100 according to one or more embodiments may include a can 120, an electrode assembly 130 accommodated inside the can 120 and a cap plate 140 coupled to an opening of the can 120 to seal the can 120. The can 120 and the cap plate 140 may form a hexagonal pillar shape with both sides closed (e.g., top and bottom), and the electrode assembly 130 may have a stacked structure in which a plurality of sheet-shaped electrodes 131 and 132 may be stacked along one direction. Current collecting plates 151 and 152 may be positioned on both sides of the electrode assembly 130.

The can 120 may include a bottom portion 121 and a side portion 122 connected to an edge of the bottom portion 121. The bottom portion 121 may be referred to as a top portion or upper surface portion when the can 120 is turned upside down. The bottom portion 121 may be a hexagonal metal plate, and the side portion 122 may be a hollow hexagonal pillar-shaped metal tube. The bottom portion 121 and the side portion 122 may be integrally connected, and the side portion 122 may be perpendicular to the bottom portion 121. The bottom portion 121 may be a regular hexagon with all six sides having the same length.

In some embodiments, an opening for installing a rivet 160 may be positioned at the center of the bottom portion 121. In other embodiments, the secondary battery 100 may be provided with a terminal of a different type than the rivet 160, and in an example embodiment, the opening in the bottom portion 121 may be omitted. The can 120 may be made of a metal, for example, steel, stainless steel, aluminum, or aluminum alloy.

Hereinafter, the direction parallel to the center axis of the can 120 may be referred to as the “length direction L” of the secondary battery, and the direction orthogonal to the length direction L in which the two surfaces of the side portion 122 face each other may be referred to as the “width direction W” of the secondary battery. The six surfaces included in the side portion 122 includes three pairs of surfaces facing each other, and the direction in which one pair of surfaces faces is referred to as the width direction W for convenience. In FIG. 2, the length direction L coincides with the vertical direction of the drawing, and the width direction W coincides with the horizontal direction of the drawing.

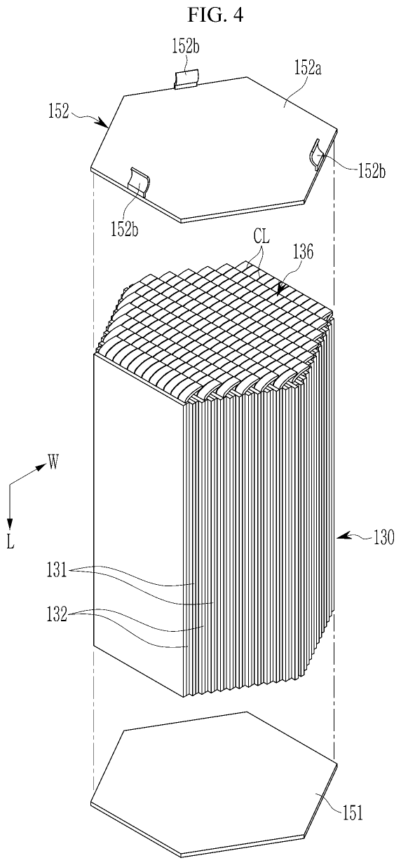

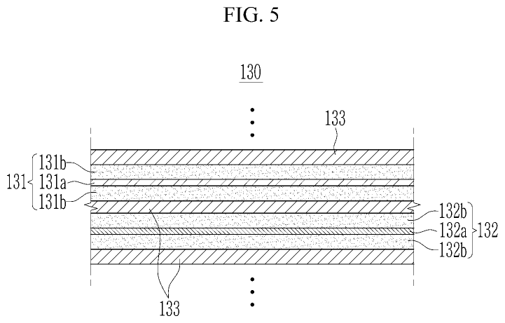

FIG. 4 is an exploded perspective view of the electrode assembly and current collecting plates of the secondary battery shown in FIG. 2 according to one or more embodiments, and FIG. 5 is a partial enlarged view of the electrode assembly in the secondary battery shown in FIG. 3 according to one or more embodiments.

Referring to FIGS. 3 to 5, the electrode assembly 130 may be formed in a plurality of sheet-shaped electrodes 131 and 132 sequentially stacked along the width direction W. Each of the plurality of electrodes 131 and 132 may be formed in a square sheet shape. The long side of each electrode 131 and 132 may be parallel to the length direction L, and the short side of each electrode 131 and 132 may be parallel to any two facing surfaces among the six surfaces included in the side portion 122.

In embodiment(s), the electrode assembly 130 may include a plurality of first electrodes 131 and a plurality of second electrodes 132 alternately arranged one by one in the width direction W, and a plurality of separators 133 positioned one by one between each adjacent first electrode 131 and second electrode 132.

Each of the plurality of separators 133 may be formed in a square sheet shape. The electrode assembly 130 may be accommodated inside the can 120 together with the electrolyte.

The first electrode 131 may include a first substrate 131a and a first active material layer 131b positioned on the first substrate 131a. The second electrode 132 may include a second substrate 132a and a second active material layer 132b positioned on the second substrate 132a. The separator 133 may insulate the first electrode 131 and the second electrode 132 while allowing movement of lithium ions.

The first substrate 131a may include aluminum (Al) foil, and the first active material layer 131b may include a transition metal oxide such as LiCoO₂, LiNiO₂, LiMn₂O₄. The second substrate 132a may include copper (Cu) foil or nickel (Ni) foil, and the second active material layer 132b may include a carbon-based material, for example, graphite. The separator 133 may include a polymer material, for example, polyethylene or polypropylene.

The electrode assembly 130 may include a plurality of electrodes 131 and 132 with different widths so as to form a hexagon on a plane (when the target portion is viewed from above). Hereinafter, “on a plane” means when the target portion is viewed from above.

Among the plurality of electrodes 131 and 132 included in the electrode assembly 130, the two outermost electrodes may have the smallest width, and the electrode positioned in the center of the electrode assembly 130 may have the largest width. The width of the electrodes 131 and 132 may gradually increase from the outside of the electrode assembly 130 toward the center. In some embodiments, the plurality of electrodes 131 and 132 may have the same height along the length direction L.

Assuming that an electrode assembly wound in a cylindrical shape is positioned inside the hexagonal pillar-shaped can 120, an empty space may exist between the electrode assembly and the edge of the can 120 in some embodiments, thereby reducing battery capacity. In other embodiments, in the secondary battery 100, the electrode assembly 130 may be disposed with minimal empty space inside the hexagonal pillar-shaped can 120, so battery output and capacity may be increased.

Referring to FIGS. 2 and 4, according to one or more embodiments, the first electrode 131 may include a first tab 135 positioned on one side (e.g., the lower side) according to the length direction and the second electrode 132 may include a second tab 136 positioned on the opposite side (e.g., the upper side) of the first tab 135.

The first tab 135 may be a portion of the first substrate 131a extending downward, and the second tab 136 may be a portion of the second substrate 132a extending upward.

A plurality of cut lines CL may be positioned on each of the first tab 135 and the second tab 136, and each of the first tab 135 and the second tab 136 may be divided into a plurality of portions by the plurality of cut lines CL. Each of the first tab 135 and the second tab 136 may be bent in one direction (e.g., bent in opposite directions) and have an overlapping portion with an adjacent tab.

In order to bend the first tab 135, a jig (not shown) may be in close contact with one of the outermost first tabs 135, and the jig may move along the width direction to sequentially press the plurality of first tabs 135 to bend them. The bending process of the second tab 136 may be performed in the same method as the bending process of the first tab 135. The plurality of cut lines CL facilitates bending of the first tab 135 and the second tab 136 during the bending process.

Each of the plurality of first tabs 135 and the plurality of second tabs 136 may overlap and press each other by bending to form a substantially flat surface. Each of the first and second current collecting plates 151 and 152 may be integrally fixed to each of the plurality of first tabs 135 and the plurality of second tabs 136 by a method such as laser welding. The first current collecting plate 151 and the second current collecting plate 152 may be formed, in embodiment(s), in a hexagonal metal plate. However, the shape of the metal plate may vary.

During the charging and discharging process of the secondary battery 100, the currents of the plurality of first electrodes 131 may be collected in the first current collecting plate 151, and the currents of the plurality of second electrodes 132 may be collected in the second current collecting plate 152. In a structure in which each of the plurality of first tabs 135 and the plurality of second tabs 136 are bent, the current collecting efficiency of the electrodes 131 and 132 may be increased, and the quality of welding with the current collecting plates 151 and 152 may be improved. In addition, since the height of the portion of the total height of the electrode assembly 130 that is not related to the active material layers 131b and 132b may be minimized, the capacity of the secondary battery 100 may be increased.

The rivet 160 may be inserted into the opening of the bottom portion 121 while surrounded by a first insulator 161, and may be coupled with the first current collecting plate 151 to be charged to the same polarity as the first electrode 131. That is, the rivet 160 may function as the first terminal (positive terminal). In order to insulate the first current collecting plate 151 and the can 120, an insulating member 162 may be positioned inside the can 120 over a part of the bottom portion 121 and the side portion 122.

Referring again to FIGS. 1 and 2, in embodiment(s), the second current collecting plate 152 may be in contact with the can 120, and the cap plate 140 may be coupled to the end of the side portion 122 while being insulated from the second current collecting plate 152 and the can 120 by a second insulator 145.

In this example embodiment, the can 120 may be charged to the same polarity as the second electrode 132 and may function as a second terminal (negative terminal), and the cap plate 140 may be electrically non-polar.

The cap plate 140 may be made of a flat metal plate or may include a central portion 141 that is convexly deformed toward the top or bottom. A notch portion 142 may be positioned on at least one of the inner and outer surfaces of the cap plate 140. The notch portion 142 may be configured as a V-shaped or U-shaped groove and may have a thinner thickness than other portions of the cap plate 140.

The notch portion 142 may function to prevent explosion of the secondary battery 100 by breaking when the internal pressure of the secondary battery 100 increases and internal gas discharged. The notch portion 142 may be positioned along the circumferential direction of the central portion 141 and, for example, may include five straight line portions parallel to five of the six sides of the cap plate 140.

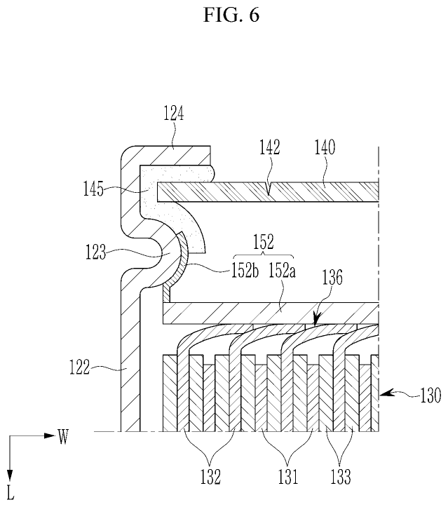

FIG. 6 is a partial enlarged view of FIG. 2 according to one or more embodiments.

Referring to FIGS. 4 and 6, the second current collecting plate 152 may include a hexagonal current collector 152a that is coupled with the plurality of second tabs 136, and a plurality of extension portions 152b may extend toward the cap plate 140 from at least two sides of the six sides of the current collector 152a.

FIG. 6 illustrates an example embodiment in which the three extension portions 152b extend from three sides of the current collector 152a toward the cap plate 140. The plurality of extension portions 152b may be arranged at equal intervals along the circumferential direction of the current collector 152a.

The side portion 122 of the can 120 may include a beading portion 123 and a crimping portion 124. The beading portion 123 may be a portion of the side portion 122 that is concave deformed toward the inner side of the can 120, and the crimping portion 124 may be an end of the side portion 122 that is bending molded toward the inner side of the can 120 to overlap the edge of the cap plate 140.

The beading portion 123 may function to suppress the movement of the electrode assembly 130, and the crimping portion 124 may function to fix the cap plate 140. The cap plate 140 may be firmly fixed to the can 120 by being pressed between the beading portion 123 and the crimping portion 124 together with the second insulator 145.

The beading portion 123 may be formed by press processing after the electrode assembly 130 and the first and second current collecting plates 151 and 152 are built into the can 120. The extension portion 152b of the second current collecting plate 152 may contact the inner surface of the beading portion 123 to conduct electricity between the second current collecting plate 152 and the can 120.

The extension portion 152b may have a predetermined curvature corresponding to the inner curvature of the beading portion 123 on cross-section (when the cross-section of the target portion is viewed from the front) and may be in close contact with the inner surface of the beading portion 123. The extension portion 152b may be insulated from the cap plate 140 by the second insulator 145. Hereinafter, ‘on cross-section’ means when the cross-section of the target portion is viewed from the front.

The extension portion 152b and the beading portion 123 may be integrally fixed by welding. For example, before the crimping portion 124 is formed, welding may be performed in a direction from the extension portion 152b toward the beading portion 123. As another example, after the crimping portion 124 is formed, welding may proceed in the direction from the beading portion 123 toward the extension portion 152b. In the former case, welding is performed inside the can 120, and in the latter case, welding is performed outside the can 120.

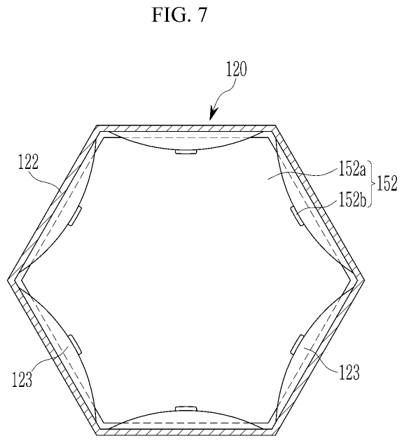

FIG. 7 is a cross-sectional view of the secondary battery cut along line C-C in FIG. 1 according to one or more embodiments.

Referring to FIGS. 1 and 7, the beading portion 123 may be independently positioned on each of the six surfaces of the side portion 122. The beading portion 123 does not extend along the circumferential direction of the side portion 122, and six beading portions 123 may be separate from each other along the circumferential direction of the side portion 122. This structure may minimize shape deformation of the side portion 122 during the process of forming the plurality of beading portions 123, for example, through press processing.

Each of the plurality of beading portions 123 may have an arc shape on a plane. That is, the depression depth of the beading portion 123 (the depth of depression from the side portion to the inside of the can) may be greatest at the center of each surface of the side portion 122, and may gradually decrease as it moves away from the center. This arc-shaped beading portion 123 is advantageous in preventing the hexagonal second current collecting plate 152 from being separated, and a decrease in the strength of the can 120 may be minimized through gradual curved line processing.

The extension portion 152b of the second collecting plate 152 may have a curvature corresponding to the inner curvature of the beading portion 123 on cross-section as shown in FIG. 6, while at the same time having a curvature corresponding to the inner curvature of the beading portion 123 on a plane as shown in FIG. 7. In some embodiments, the contact area between the extension portion 152b and the beading portion 123 may be expanded, so that electricity may be smoothly passed between them, and welding quality may be improved.

The plurality of beading portions 123 may be formed at intervals using one pressing portion (not shown). The manufacturing method of the beading portion 123 will be described in detail in the manufacturing method of the secondary battery subsequently described.

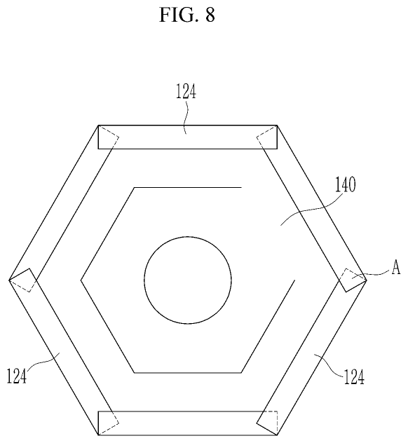

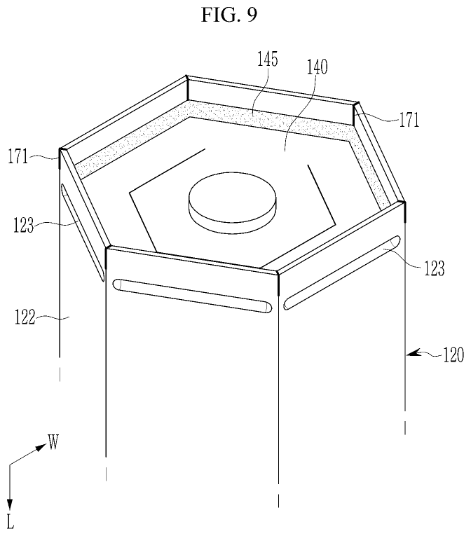

FIG. 8 is a top plan view of the secondary battery shown in FIG. 1 according to one or more embodiments, and FIG. 9 is a perspective view showing a state before bending molding of the crimping portion of the secondary battery shown in FIG. 1 according to one or more embodiments.

Referring to FIGS. 8 and 9, the crimping portion 124 may be divided into a plurality of pieces by cutouts. In the present embodiment, the cutout may be formed as a cut line 171. In the state before bending of the crimping portion 124, the cut line 171 may be positioned parallel to the length direction L at the top of each of the six corners of the side portion 122.

The second insulator 145 and the cap plate 140 may be positioned inside the can 120 above the second current collecting plate 152, and the plurality of crimping portions 124 may be bent vertically toward the inside of the can 120 to overlap the edge of the cap plate 140. The plurality of crimping portions 124 may be easily bent by the cut line 171 without interfering with adjacent crimping portions 124 during the bending process. Each of the plurality of crimping portions 124 may have a quadrangle overlapping portion A with the adjacent crimping portions 124 on a plane.

In some embodiments, the cut line 171 may not be positioned on the side portion 122, such that the finishing quality may deteriorate, such as wrinkles forming at the corners or multiple layers of corners overlapping during the process of creating the crimping portion by bending. In other embodiments, the six crimping portions 124 are neatly bent without mutual interference, thereby improving the finishing quality of the secondary battery 100 and increasing the fixing force of the cap plate 140.

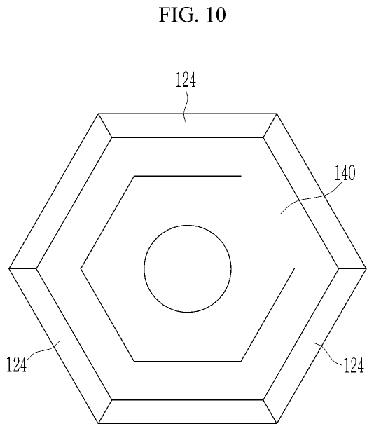

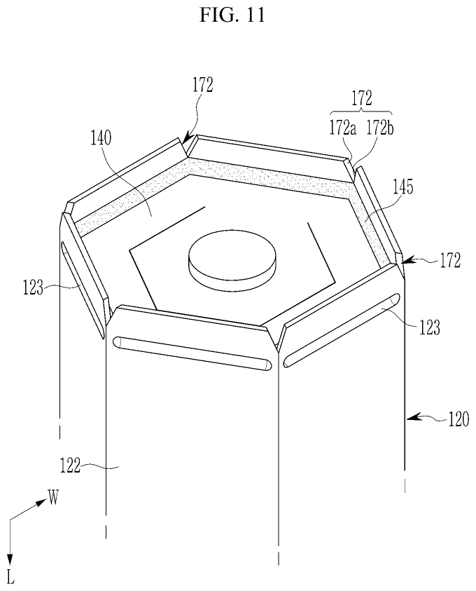

FIG. 10 is a top plan view of a secondary battery according to one or more embodiments, and FIG. 11 is a perspective view showing a state before bending molding of the crimping portion of the secondary battery shown in FIG. 10 according to one or more embodiments. In some embodiments, the secondary battery may have the same or similar configuration as described above, except for the crimping portion described below.

Referring to FIGS. 10 and 11, the crimping portion 124 is divided into a plurality of pieces by cutouts. According to the present embodiment, the cutouts may be formed as a V-shaped or wedge-shaped cut groove 172. In a state before bending of the crimping portion 124, the cut groove 172 may be positioned parallel to the length direction L at each of the six corners of the side portion 122.

The cut groove 172 may include a first cut line 172a that cuts one surface of the side portion 122 in a diagonal direction, and a second cut line 172b that cuts the other adjacent surface in a diagonal direction. The first cut line 172a and the second cut line 172b may meet at the corner of the side portion 122 to form a V shape or a wedge shape.

Each of the plurality of crimping portions 124 overlaps an edge of the cap plate 140 by bending and fixes the cap plate 140. Each of the plurality of crimping portions 124 may contact each other on the side surface without overlapping with the adjacent crimping portions 124 on a plane. That is, the plurality of crimping portions 124 may be in contact with each other on the sides to form a hexagonal ring shape as shown in FIG. 10. The crimping portion 124 of the above-described configuration may improve the finishing quality of the hexagonal pillar-shaped secondary battery 100.

The manufacturing method of the secondary battery will now be described.

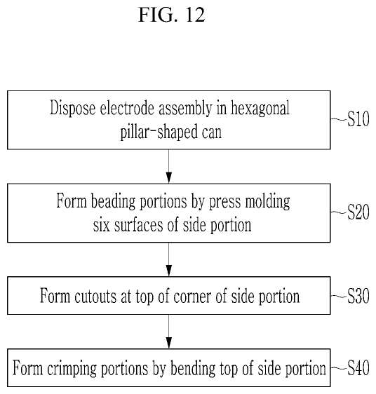

FIG. 12 is a process flowchart showing a manufacturing method of a secondary battery according to one or more embodiments.

Referring to FIG. 12, a manufacturing method of a secondary battery may include accommodating an electrode assembly, in which a hexagonal pillar-shaped can including a bottom portion and a side portion may be prepared, and the electrode assembly may be disposed inside the can (S10), processing of beading portions, in which each of the six surfaces of the side portion may be individually press molded to create a plurality of beading portions (S20), processing of cutouts, in which an insulator may be disposed over the beading portions and a plurality of cutouts may be created at the top of corner of the side portion (S30), and processing of the crimping portions, in which a cap plate may be disposed at the center of the insulator and the top of the side portion may be bending molded toward the center of the cap plate to create a plurality of crimping portions (S40).

Referring to FIGS. 1, 2, and 12, in the accommodating of the electrode assembly (S10), the can 120 may include the hexagonal bottom portion 121 and the side portion 122 with six surfaces. An opening may be positioned in the center of the bottom portion 121, and the first insulator 161 and the rivet 160 may be inserted into the opening and installed in the bottom portion 121. In addition, the insulating member 162 may be disposed inside the can 120 to surround the rivet 160.

Referring to FIGS. 2, 4, and 12, the electrode assembly 130 may include a plurality of sheet-shaped electrodes 131 and 132 stacked along the width direction, forming a hexagon on a plane. The first current collecting plate 151 may be fixed to the plurality of first tabs 135, and the second current collecting plate 152 may be fixed to the plurality of second tabs 136. The second current collecting plate 152 may include the current collector 152a and the plurality of extension portions 152b. The electrode assembly 130 integrally coupled with the first and second current collecting plates 151 and 152 may be accommodated inside the can 120.

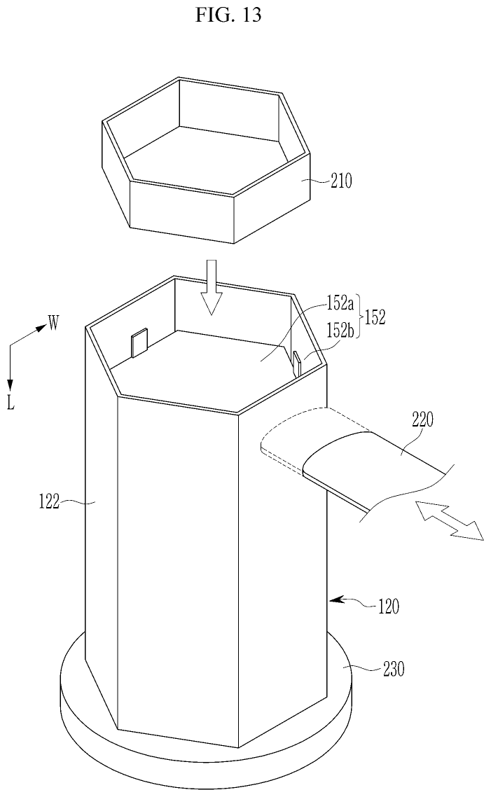

FIG. 13 is a schematic perspective view of a can, a first pressing portion and a rotating portion for explaining processing of beading portions shown in FIG. 12, according to one or more embodiments.

Referring to FIG. 13, a jig 210, a first pressing portion 220, and a rotating portion 230 may be used to process the beading portions 123. The jig 210 may be a hexagonal tubular structure, may be manufactured in a smaller size than the side portion 122 of the can 120, and may be positioned inside the side portion 122 above the second current collecting plate 152. The distance between the inner surface of the side portion 122 and the outer surface of the jig 210 may correspond to the maximum depression depth of the beading portion 123. The extension portion 152b of the second current collecting plate 152 may be positioned between the inner surface of the side portion 122 and the jig 210.

The first pressing portion 220 may be positioned on the outside of one of the six surfaces of the side portion 122, may form the beading portion 123 by pressing the side portion 122, and may then return to the initial position. In this process, the jig 210 limits the entry depth of the first pressing portion 220 so that the beading portion 123 of a predetermined depth and shape may be created.

The width of the first pressing portion 220 may be smaller than the width of one surface of the side portion 122, and one side of the first pressing portion 220 facing the side portion 122 may be formed in an arc shape. Therefore, the beading portion 123 formed on one surface of the side portion 122 may have an arc shape on a plane as shown in FIG. 7, and the depression depth of the beading portion 123 may have the largest value at the center of each surface of the side portion 122.

The rotating portion 230 supports the can 120, and after one beading portion 123 is formed, the rotating portion 230 may be rotated 60° so that the other surface of the side portion 122 faces the first pressing portion 220. Six beading portions 123 may be made sequentially by repeating the process of making the beading portions 123 by operation of the first pressing portion 220 and rotating the can 120 by 60° by operation of the rotating portion 230.

The plurality of beading portions 123 may be independently positioned on each surface of the side portion 122, and may minimize shape deformation and strength reduction of the can 120.

The extension portion 152b of the second current collecting plate 152 may be deformed together with the side portion 122 during the processing of the beading portion 123. That is, the extension portion 152b may have a curvature corresponding to the inner curvature of the beading portion 123 both on cross-section and on a plane. After processing the beading portions 123, the jig 210 may be separated from the can 120, and the extension portion 152b and the beading portions 123 may be integrally fixed by welding.

Referring to FIGS. 9, 11, and 12, in the processing of the cutouts (S30), the ring-shaped second insulator 145 may be disposed over the plurality of beading portions 123, and by methods such as laser cutting, a plurality of cutouts parallel to the length direction L may be made on the top of each of the six corners of the side portion 122.

The cutout may be made of the cut line 171 (see FIG. 9) or a V-shaped or wedge-shaped cut groove 172 (see FIG. 11). The plurality of cut lines 171 and the plurality of cut grooves 172 may have the same length and may facilitate bending of the side portion 122 in the processing of the crimping portion (S40) described next. After the processing of the cutouts (S30), a liquid electrolyte may be injected into the inside of the can 120.

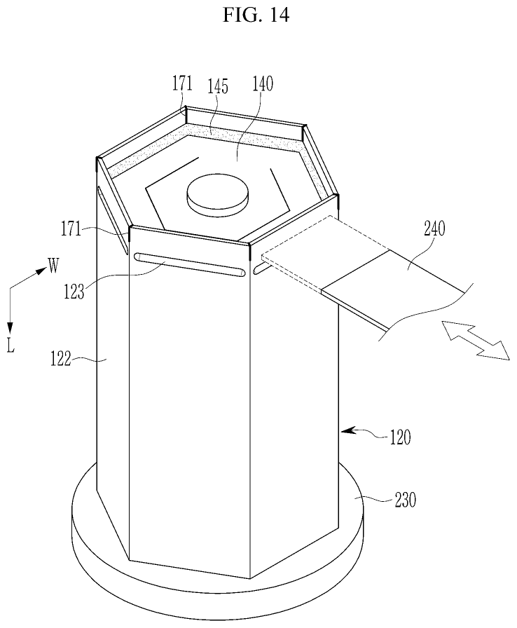

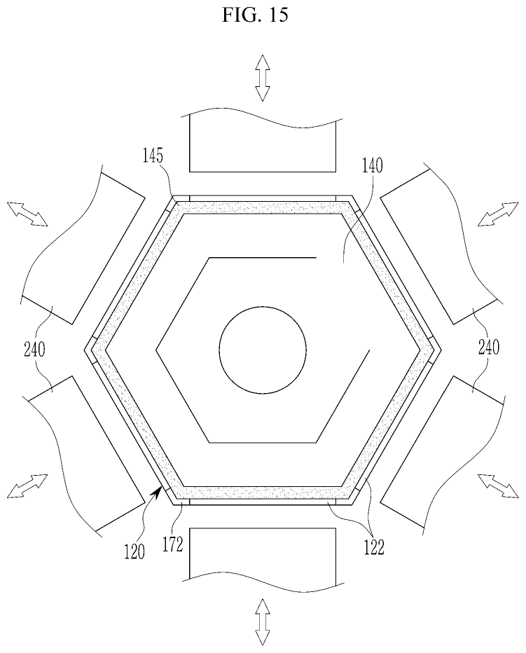

FIG. 14 is a schematic perspective view of a can, a second pressing portion, a rotating portion for explaining processing of the crimping portions shown in FIG. 12 and FIG. 15 is a top plan view of the can and the second pressing portion for explaining processing of the crimping portions shown in FIGS. 8 and 9, according to one or more embodiments.

Referring to FIGS. 8 and 14, when the cutout is formed with the cut line 171, a second pressing portion 240 and a rotating portion 230 may be provided for processing the crimping portions 124. The second pressing portion 240 may be positioned to face one surface of the side portion 122, and the rotating portion 230 may be positioned below the can 120 to support the can 120.

In the processing of the crimping portions (S40), the cap plate 140 may be disposed at the center of the second insulator 145. Subsequently, the top of the side portion 122 on one surface of the side portion 122 may be vertically bent by the operation of the second pressing portion 240 and may be processed into the crimping portion 124. Then, the rotating portion 230 may be rotated by 60° so that the other surface of the side portion 122 faces the second pressing portion 240.

By operating the second pressing portion 240, the crimping portion 124 is created on the other surface of the side portion 122, and the rotating portion 230 may rotate again by 60°. By repeating this process, six crimping portions 124 may be sequentially created.

Each of the plurality of crimping portions 124 may have a quadrangle overlapping portion with the adjacent crimping portions 124 on a plane. The plurality of crimping portions 124 may be easily processed without interfering with adjacent crimping portions 124 by the cut line 171, and the finishing quality of the secondary battery 100 may be improved.

Referring to FIGS. 11 and 15, when the cutout is made of the cut groove 172, six second pressing portions 240 may be positioned to face the six surfaces of the side portion 122. Six second pressing portions 240 may simultaneously press the top of the side portion 122 from six surfaces of the side portion 122, and in this embodiment, six crimping portions 124 may be processed simultaneously. In another embodiment, the six crimping portions 124 may be processed sequentially using the second pressing portion 240 and the rotating portion 230 shown in FIG. 14.

Each of the plurality of crimping portions 124 may be in contact with the adjacent crimping portions 124 on a plane, as shown in FIG. 10. The plurality of crimping portions 124 may be easily processed without interference with the adjacent crimping portions 124 through the cut groove 172, and the finishing quality of the secondary battery 100 may be improved.

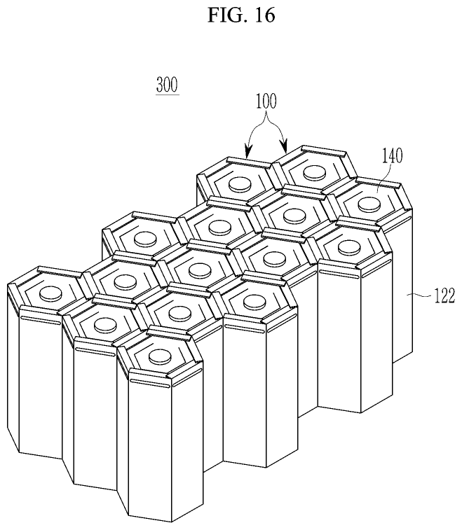

FIG. 16 is a schematic diagram of a battery module according to one or more embodiments.

Referring to FIG. 16, a battery module 300 may include a plurality of secondary batteries 100 situated so that the side portions 122 of the cans 120 are in contact with each other. The plurality of secondary batteries 100 may include any one of the above-described embodiments. The plurality of secondary batteries 100 may be disposed in close contact with each other on the side portion 122 of the hexagonal pillar-shaped can 120 without dead space.

In a battery module including a plurality of cylindrical secondary batteries, an empty space may be generated between adjacent secondary batteries, but in the battery module 300 of the present embodiment, an empty space may not be generated between adjacent secondary batteries 100. The battery module 300 of the present embodiment has a structure that increases space efficiency and is advantageous for increasing output and capacity.

The present disclosure provides a secondary battery and a manufacturing method capable of improving the output and capacity of the battery module by increasing the integration of the secondary batteries when forming a battery module by combining a plurality of secondary batteries.

According to embodiments, the electrode assembly may be disposed while minimizing empty space inside the hexagonal pillar-shaped can, thereby increasing battery output and capacity. In addition, since the plurality of crimping portions are neatly bending molded without mutual interference by the plurality of cutouts, the finishing quality of the secondary battery may be improved and the fixing force of the cap plate may be increased.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A secondary battery, comprising:
a can including a hexagonal bottom portion and a side portion having six surfaces;
an electrode assembly accommodated inside the can; and
a hexagonal cap plate coupled to an end of the side portion to seal the can,
wherein the side portion comprises a plurality of beading portions, a beading portion of the plurality of beading portions situated on each of the six surfaces and a plurality of crimping portions divided by a plurality of cutouts.

2. The secondary battery as claimed in claim 1, wherein
the electrode assembly includes a plurality of electrodes with different widths stacked along a width direction of the secondary battery, and is in the shape of a hexagon on a plane.

3. The secondary battery as claimed in claim 2, wherein
each of the plurality of electrodes has a square sheet shape, and
the long side of each of the plurality of electrodes is parallel to a length direction of the secondary battery, and a short side of each of the plurality of electrodes is positioned parallel to any two facing surfaces among the six surfaces included in the side portion.

4. The secondary battery as claimed in claim 1, wherein
the electrode assembly comprises a plurality of first tabs positioned on one side toward the hexagonal bottom portion and a plurality of second tabs positioned on another side toward the cap plate, and
the secondary battery further comprises:
a first current collecting plate connected to the plurality of first tabs; and
a second current collecting plate connected to the plurality of second tabs.

5. The secondary battery as claimed in claim 4, wherein
an opening is positioned on the hexagonal bottom portion, and
the secondary battery further comprises a rivet inserted into the opening via a first insulator and electrically connected to the first current collecting plate.

6. The secondary battery as claimed in claim 4, wherein
the second current collecting plate includes a hexagonal current collector and a plurality of extension portions connected to at least two of the six sides of the current collector and in contact with an inner surface of a beading portion of the plurality of beading portions.

7. The secondary battery as claimed in claim 6, wherein
each of the plurality of beading portions has an arc shape on a plane, and
each of the plurality of extension portions having a curvature corresponding to an inner curvature of the beading portion on a plane.

8. The secondary battery as claimed in claim 1, wherein
the plurality of cutouts comprise a plurality of cut lines positioned parallel to a length direction of the secondary battery at an end of each of the six corners of the side portion, and
each of the plurality of crimping portions has an overlapping portion with an adjacent crimping portion.

9. The secondary battery as claimed in claim 1, wherein
the plurality of cutouts comprise a plurality of V-shaped cut grooves positioned parallel to a length direction of the secondary battery at an end of each of the six corners of the side portion, and
each of the plurality of crimping portions is in contact with an adjacent crimping portion on a side surface.

10. A manufacturing method of a secondary battery, the method comprising:
accommodating an electrode assembly in a can, the can including a hexagonal bottom portion and a side portion having six surfaces is prepared;
processing a plurality of beading portions, the processing including individually press molding each of the six surfaces of the side portion to create a plurality of beading portions;
processing cutouts by applying an insulator over the plurality of beading portions and creating a plurality of cutouts parallel to a length direction of the secondary battery at each end of six corners of the side portion; and
processing crimping portions by disposing a cap plate at a center of the insulator and an end of the side portion is bending molded toward the center of the cap plate to create a plurality of crimping portions.

11. The manufacturing method of the secondary battery as claimed in claim 10, wherein in the processing of the plurality of beading portions,
a jig is positioned inside the side portion, a first pressing portion having an arc shape on one side facing the side portion and a rotating portion supporting the can, and
press molding using the first pressing portion and rotating the rotating portion of the can by 60°, wherein the press molding is repeatedly performed.

12. The manufacturing method of the secondary battery as claimed in claim 10, wherein in the processing of the cutouts,
the plurality of cutouts include a plurality of cut lines, and
wherein in the processing of the crimping portions,
a second pressing portion and a rotating portion supporting the can are used, and
bending molding using the second pressing portion and rotation of the can by 60° by the rotating portion are repeatedly performed.

13. The manufacturing method of the secondary battery as claimed in claim 12, wherein in the processing of the crimping portions,
each of the plurality of crimping portions has an overlapping portion with an adjacent crimping portion.

14. The manufacturing method of the secondary battery as claimed in claim 10, wherein in the processing of the cutouts,
the plurality of cutouts include a plurality of cut grooves, and
wherein in the processing of the crimping portions,
six second pressing portions corresponding to each of the six surfaces of the side portion are used, and
the six second pressing portions simultaneously bending-mold the ends of the side portion.

15. The manufacturing method of the secondary battery as claimed in claim 14, wherein in the processing of the crimping portions,
each of the plurality of crimping portions is in contact with an adjacent crimping portion on a side surface.
